(19) United States
(12) Patent Application Publication
(10) Pub. No.: US 2016/0221294 A1
(43) Pub. Date: Aug. 4, 2016

(54) FLEXIBLE DISPLAY DEVICE HAVING FLEXIBLE WINDOW SUBSTRATE

(71) Applicant: SAMSUNG DISPLAY CO., LTD., Yongin-si (KR)

(72) Inventors: Min-Hoon Choi, Seoul (KR); Jeoung Sub Lee, Seoul (KR); Sang-Il Park, Yongin-si (KR); Hyun Joon Oh, Seongnam-si (KR); Hye-Jin Oh, Asan-si (KR); In Sun Hwang, Suwon-si (KR)

(21) Appl. No.: 14/822,774

(22) Filed: Aug. 10, 2015

(30) Foreign Application Priority Data
Jan. 30, 2015 (KR) 10-2015-0015564

(51) Int. Cl. B32B 3/16; B32B 7/12; G06F 3/041; B32B 7/02

(52) U.S. Cl. CPC B32B 3/16; B32B 7/02; B32B 7/12; G06F 3/041; B32B 2250/04; B32B 2307/412; B32B 2307/536; B32B 2457/208; G06F 2203/04102

(57) ABSTRACT

Disclosed herein is a flexible display device including a display panel displaying an image, a touch screen panel on the display panel, and a window substrate covering the touch screen panel. The window substrate includes: a flexible base layer including a first surface facing an outside and a second surface facing the display panel in an opposite direction to the first surface; and a coating layer having hardness higher than that of the base layer and having a plurality of coating tiles arranged on the first surface of the base layer thereof, each coating tile being spaced from adjacent ones of the coating tiles.

### CROSS-REFERENCE TO RELATED APPLICATION

This application claims priority to and the benefit of Korean Patent Application No. 10-2015-0015564 filed in the Korean Intellectual Property Office on Jan. 30, 2015, the entire contents of which are incorporated herein by reference.

### BACKGROUND

1. Field

The described technology relates generally to a display device.

2. Description of the Related Art

A display device is a device which visually displays data. Generally, the display device, which is generally one of the output devices of a computer, is a device which enables a user to directly see results processed by the computer with his/her eyes by displaying the results on a screen. Types of display devices include cathode ray tubes (CRTs), liquid crystal displays (LCDs), organic light emitting diode displays (OLED displays), electrophoretic displays (EPDs), and the like. With recent developments in the field of display devices, display devices are currently not limited to a function as output devices of the computer but has been variously applied to an application field such as a television receiver, portable communication devices, wearable electronic devices, and the like.

Among the display devices, liquid crystal displays, organic light emitting diode displays, electrophoretic displays, and the like, which may be manufactured as a module having a flat panel shape, may easily have a large area, a thin profile, and reduced weight, and as a result, have taken the lead in the display industry. Further, a flexible display device, which may be bent, rolled, or stretched as a whole by an external force by adopting a flexible or stretchable material as a material of a substrate, has been developed.

A touch screen panel has been developed to be able to use an input scheme which may replace input schemes such as a mouse and a keyboard so as to directly input information onto a screen using a hand or a pen. Any user may directly perform his/her desired operation while viewing a screen of the touch screen panel and easily operate the touch screen panel, and therefore the touch screen panel has been evaluated as the most ideal input scheme under the graphical user interface (GUI) environment and has been widely used in various fields such as a control screen of mobile phones, tablet computers, various kinds of medical equipment and an information display for guiding a bank, a government office, a tourist, and main institutions. The touch screen panel is used by being combined with a flat panel display, such as a liquid crystal display (LCD) and an organic light emitting diode (OLED) display, or a flexible display device.

Although the touch screen panel is applied to the flexible display device, a window layer at an outermost side of the flexible display device has flexible characteristics, and therefore a surface thereof may be easily damaged due to a contact of a hand or a touch pen. When the window layer is made of a rigid material to prevent or reduce the damage to the surface, the flexibility of the display device may be decreased.

The above information disclosed in this Background section is only for enhancement of understanding of the background of the described technology and therefore it may contain information that does not form prior art.

### SUMMARY

According to embodiments of the present invention, a flexible display has a flexible window substrate capable of being bent or expanded or contracted by an external force.

The described technology provides a flexible display device capable of concurrently implementing flexibility and high hardness characteristics by forming a plurality of independently segmented coating layers from a high hardness material on a window substrate made of a flexible material.

Further, embodiments of the present invention provide a flexible window substrate having a plurality of independently segmented coating layers from a high hardness material on a surface thereof to be applied to a flexible display device.

An exemplary embodiment provides a flexible display device including: a display panel for displaying an image, a touch screen panel on the display panel, and a window substrate covering the touch screen panel. The window substrate may include: a flexible base layer including a first surface facing an outside and a second surface facing the display panel in an opposite direction to the first surface; and a coating layer having hardness higher than that of the base layer and having a plurality of coating tiles arranged on the first surface of the base layer thereof, each coating tile being spaced from adjacent ones of the coating tiles.

The plurality of coating tiles may each be isolated from each other.

The plurality of coating tiles may be arranged in a matrix form.

The window substrate may be divided into a display area configured to display an image and a non-display area which encloses the display area and the coating layer may be at an area which corresponds to the display area.

A thickness of the coating tiles may be between 10 μm and 100 μm.

When a curvature radius of a tip of a touch pen which is used by contacting a surface of the window substrate is set to be r and a thickness of the coating tiles is set to be d, and a maximum gap between the coating tiles adjacent to each other is set to be S, the maximum gap may satisfy

S≦2\sqrt{d(2r−d)}.

The gap between the coating tiles adjacent to each other may be between 20 μm and 200 μm.

The coating tiles may have a quadrangular plane shape.

The coating tiles may have a parallelogrammic plane shape and the coating tiles may be arranged so that respective corners of four of the parallelogrammic coating tiles are adjacent to one point and the coating tiles may be arranged with the same inclination direction.

The coating tiles may have a trapezoidal plane shape, the coating tiles may be arranged so that respective corners of four of the trapezoid coating tiles are adjacent to one point, and inclined sides of the trapezoids adjacent to each other in a first direction may be alternately reversed and arranged to be parallel with each other.

The coating tiles may have a triangular plane shape.

The coating tiles may be arranged so that respective corners of six of the triangular coating tiles are adjacent to a point.

An allowable maximum gap between the coating tiles may be between the corners of the coating tiles facing each other to be symmetrical to each other.

The coating tiles may have a hexagonal plane shape.

The coating tiles may be arranged so that respective corners of three of the hexagonal coating tiles are adjacent to a point.

An allowable maximum gap between the coating tiles may be a gap which is between adjacent sides of the coating tiles.

The base layer may be made of a material selected from the group consisting of elastomer, polyethylene terephthalate (PET), polyethylene naphthalate (PEN), polyimide (PI), polymethyl methacrylate (PMMA), silicone, polyurethane (PU), and combinations thereof.

The coating tiles may be made of a material selected from the group consisting of epoxy, acryl, silicone, polyurethane (PU), graphene, carbon nanotube (CNT), indium tin oxide (ITO), indium zinc oxide (IZO), Si, SiOx, SiNx, and combinations thereof.

As described above, according to the flexible display device of an exemplary embodiment, it is possible to concurrently implement the flexibility and high hardness characteristics by forming the plurality of independently segmented coating layers from the high hardness material on the window substrate made of the flexible material.

### BRIEF DESCRIPTION OF THE DRAWINGS

FIG. 1 is a perspective view illustrating a flexible display device according to an exemplary embodiment.

FIG. 2 is a partial cross-sectional view taken along the line II-II of FIG. 1.

FIG. 3 is a plan view of a window substrate of the flexible display device according to an exemplary embodiment.

FIG. 4 is a diagram for describing a gap design condition of a coating tile formed on the window substrate of the flexible display device according to an exemplary embodiment.

FIG. 5 is a plan view illustrating a coating layer pattern formed on a window substrate of a flexible display device according to another exemplary embodiment.

FIG. 6 is a plan view illustrating a coating layer pattern formed on a window substrate of a flexible display device according to still another exemplary embodiment.

FIG. 7 is a plan view illustrating a coating layer pattern formed on a window substrate of a flexible display device according to still another exemplary embodiment.

FIG. 8 is a plan view illustrating a coating layer pattern formed on a window substrate of a flexible display device according to still another exemplary embodiment.

### DETAILED DESCRIPTION

In the following detailed description, certain exemplary embodiments have been shown and described, simply by way of illustration. As those skilled in the art would realize, the described embodiments may be modified in various suitable ways, all without departing from the scope of the present invention. The drawings and description are to be regarded as illustrative in nature and not restrictive. Like reference numerals designate like elements or components throughout the specification. In addition, the size and thickness of each configuration shown in the drawings are arbitrarily shown for understanding and ease of description, but the embodiments of the present invention are not limited thereto.

Further, in the specification, the word “on” means positioning on or below the object portion, but does not essentially mean positioning on the upper side of the object portion based on a gravity direction. In addition, unless explicitly described to the contrary, the word “comprise” and variations such as “comprises” or “comprising”, will be understood to imply the inclusion of stated elements or components but not the exclusion of any other elements or components.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first”, “second”, “third”, etc., may be used herein to describe various elements, components, regions, layers, and/or sections, these elements, components, regions, layers and/or sections should not be limited by these terms. These terms are only used to distinguish one element, component, region, layer or section from another element, component, region, layer or section. Thus, a first element, component, region, layer, or section discussed below could be termed a second element, component, region, layer, or section, without departing from the spirit and scope of the present invention.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

The terminology used herein is for the purpose of describing particular embodiments only and is not intended to be limiting of the present invention. As used herein, the singular forms “a” and “an” are intended to include the plural forms as well, unless the context clearly indicates otherwise.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include ail higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112, first paragraph, and 35 U.S.C. §132(a).

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

Hereinafter, a flexible display device according to an exemplary embodiment will be described in detail with the accompanying drawings.

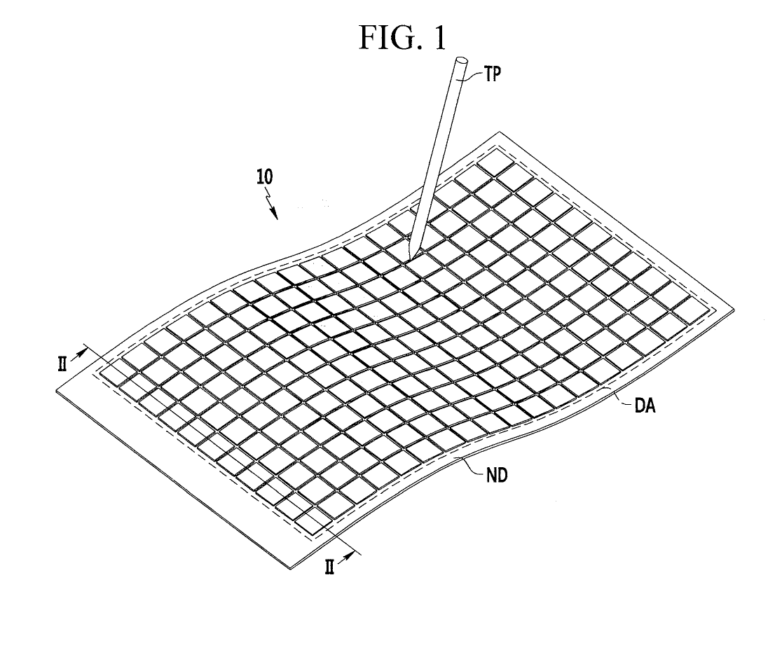

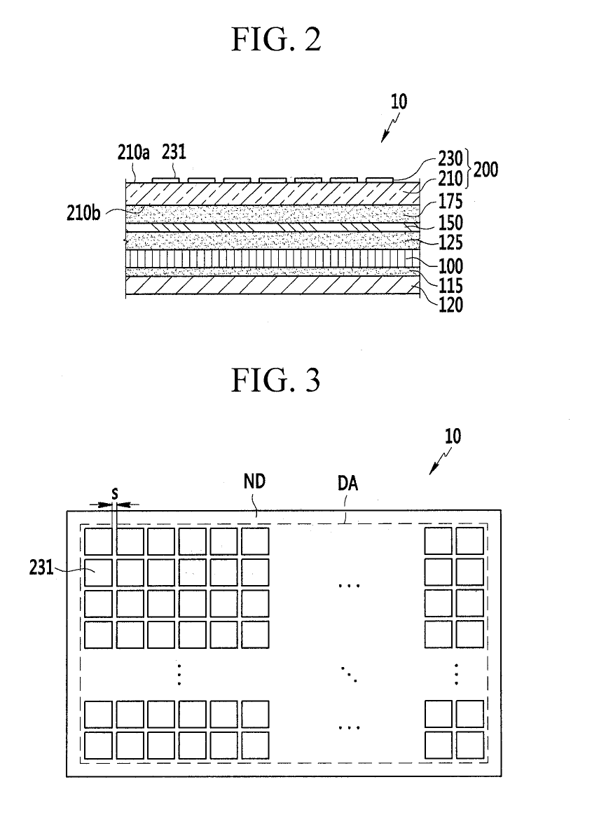

FIG. 1 is a perspective view illustrating a flexible display device according to an exemplary embodiment and FIG. 2 is a partial cross-sectional view taken along the line II-II of FIG. 1.

Referring to FIG. 1, a flexible display device 10 according to an exemplary embodiment has a structure in which a display panel and a touch screen panel are protected by being covered with a window substrate, in which the window substrate 200 may be divided into a display area DA displaying an image and a non-display area ND having a driving circuit unit, a frame, and the like positioned thereon. The window substrate 200 includes a base layer 210 made of a flexible material and a coating layer 230 in which a plurality of coating tiles 231 are arranged on and attached to a surface toward an outside of the base layer 210 at a distance from each other.

For an input onto the display screen, a touch pen TP may be used by contacting a surface of the window substrate 200. Therefore, the coating layer 230 is formed by attaching a plurality of coating tiles 231 to the base layer 210 of the window substrate 200 corresponding to at least the display area DA and the coating tile 231 includes a material having hardness higher than that of the base layer 210.

A cross section configuration of the flexible display device 10 according to an exemplary embodiment will be described in more detail from FIG. 2, in which a touch screen panel 150 is attached to an upper portion of the display panel 100 and the window substrate 200 is attached to an upper portion of the touch screen panel 150 to cover the display panel 100 and the touch screen panel 150.

The display panel 100 includes a plurality of pixels which are arranged in a matrix form to display an image and may be configured of an organic light emitting panel according to an exemplary embodiment. The display panel 100 may be formed on a flexible substrate to have flexible characteristics and therefore may be configured of a curved panel or a bendable, foldable, rollable, or stretchable panel.

A lower protective film 120 is provided under the display panel 100 to protect the display panel 100. The lower protective film 120 may be formed of a flexible plastic film, for example, polyimide (PI) or polyethylene terephthalate (PET). A display panel adhesive layer 115 may be interposed between the lower protective film 120 and the display panel 100 to attach the display panel 100 to the lower protective film 120. The display panel adhesive layer 115 may be made of an optically clear adhesive (OCA) and may be applied in an adhesive tape form or may also be applied by applying and hardening an adhesive material.

An optical film may be attached on the display panel 100. As another example, the optical film may also be positioned on the touch screen panel 150. The optical film may include a polarization film and a phase difference film, in which the polarization film may polarize light incident on the display panel and light obtained by reflecting the incident light from the display panel and the phase difference film may be adjacently disposed on the display panel rather than on the polarization film to control a phase of the incident light and the reflected light.

The touch screen panel 150 is attached over the display panel 100. When the optical film is attached on the display panel 100, the touch screen panel 150 is positioned over the optical film. A TSP adhesive layer 125 may be interposed between the display panel 100 and the touch screen panel 150 to attach the touch screen panel 150 to the display panel 100. The TSP adhesive layer 125 may be made of an optically clear adhesive (OCA) and may be applied in an adhesive tape form or may also be applied by applying and hardening an adhesive material.

The touch screen panel 150 may sense the touch position input from the outside, and the window substrate 200 is combined on the touch screen panel 150 to sense the touch position generated from the window substrate 200. According to an exemplary embodiment, the touch screen panel 150 may be formed of a panel which is driven with a capacitive type but the present invention is not limited thereto, and therefore the touch screen panel 150 may also be formed of a panel which is driven with a resistive film type, an ultrasonic type, and/or an infrared type.

The window substrate 200 is formed to have an area larger than that of the display panel 100 and the touch screen panel 150 to cover the display panel 100 and the touch screen panel 150. The window adhesive layer 175 is interposed between the touch screen panel 150 and the window substrate 200 to attach the window substrate 200 to the touch screen panel 150. The window adhesive layer 175 may be made of an optically clear adhesive (OCA) and may be applied in an adhesive tape form or may also be applied by applying and hardening an adhesive material.

Referring to FIG. 2, the window substrate 200 according to an exemplary embodiment includes the flexible base layer 210 having a first surface 210a facing the outside and a second surface 210b facing the display panel 100 in an opposite direction thereto and the coating layer 230 in which the plurality of coating tiles 231 are arranged on and attached to the first surface 210a of the base layer 210 at a gap from each other. The coating tile 231 includes a material having hardness higher than that of the base layer 210.

For example, the base layer 210 may be made of a material selected from the group consisting of elastomer, polyethylene terephthalate (PET), polyethylene naphthalate (PEN), polyimide (PI), polymethyl methacrylate (PMMA), silicone, polyurethane (PU), and combinations thereof. The coating tile 231 may be made of a material selected from the group consisting of epoxy, acryl, silicone, polyurethane (PU), graphene, carbon nanotube (CNT), indium tin oxide (ITO), indium zinc oxide (IZO), Si, SiOx, SiNx, and combinations thereof.

FIG. 3 is a plan view of a window substrate of the flexible display device according to an exemplary embodiment.

Referring to FIG. 3, the plurality of coating tiles 231 configuring the window substrate 200 of the flexible display device 10 according to an exemplary embodiment are each formed to be isolated from each other while having the same or substantially the same plane shape and are arranged in a matrix form. The window substrate 200 may be divided into a display area DA for displaying an image and a non-display area ND surrounding the display area DA, and the coating layer 230 configured of the coating tile 231 may be at an area corresponding to the display area DA.

According to an exemplary embodiment, each coating tile 231 may have a square plane shape and gaps s formed between the coating tiles 231 adjacent to each other may be arranged to have a uniform space in all directions on a plane.

The number and each area of the coating tile 231 included in the coating layer 230 may be determined and selected depending on a size and designed flexibility of the display device. Each coating tile 231 may be formed at a size corresponding to at least one pixel and may also be formed to have the same or substantially the same area in all the layers.

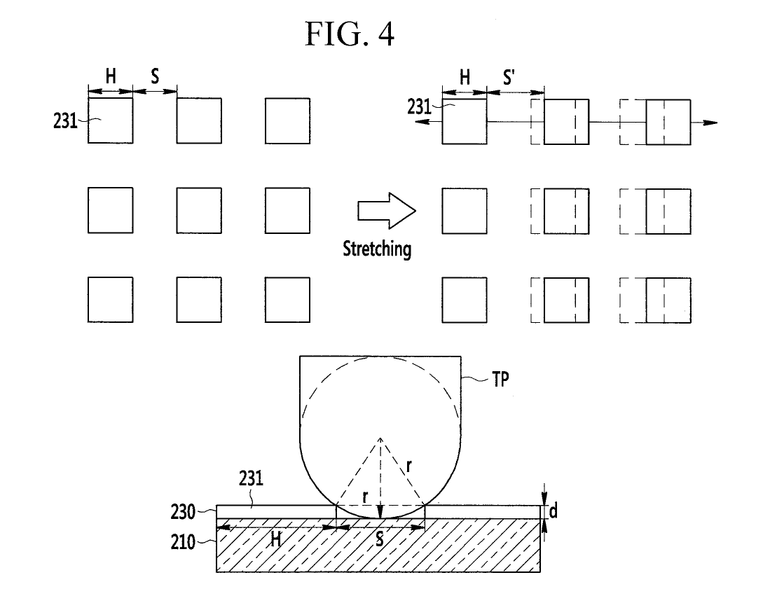

FIG. 4 is a diagram for describing a gap design condition of a coating tile formed on the window substrate of the flexible display device according to another exemplary embodiment.

Referring to FIG. 4, when a curvature radius of a tip of a touch pen TP which is used by contacting the surface of the window substrate 200 according to the another exemplary embodiment is set to be r, the thickness of the coating tile 231 formed on the coating layer 230 of the window substrate 200 is d, and the maximum gap between the coating tiles 231 adjacent to each other is set to be S, the maximum gap S may be formed to satisfy the following Equation 1.

S≦2\sqrt{d(2r−d)} Equation 1

The gap design process of the coating tile 231 will be described based on the above Equation 1.

First, when the thickness d of the coating tile 231 is set to be 10 μm, the maximum gap S depending on the curvature radius r of the tip of the touch pen TP is shown in the following Table 1.

TABLE 1

| | Curvature radius r of | |
|---|---|---|
| | tip of touch pen | Maximum gap (S) |
| | [mm] | [μm] |
| Thickness of | 0.01 | 20 |
| coating tile | 0.05 | 60 |
| d = 10 μm | 0.1 | 87.2 |
| | 0.5 | 199.0 |
| | 0.7 | 235.8 |
| | 1.0 | 282.1 |

Next, if it is assumed that an elongation of the window substrate 200 is 30% and 100%, the following Table 2 shows a pitch of the coating tiles 231, a width H of the coating tile 231, and gaps S and S′ between the coating tiles 231 before the window substrate 200 is stretched, after the window substrate 200 is stretched by 30%, and the window substrate 200 is stretched by 100%. The pitch of the coating tile 231 may be obtained by a summed value of the width H and the gaps S and S′ and the maximum gap before the window substrate 200 is stretched is set to be S and the maximum gap after the window substrate 200 is stretched is set to be S′. Further, it is assumed that the width H and the maximum gap S of the coating tile 231 before the window substrate 200 is stretched are designed to be the same or substantially the same.

TABLE 2

| Before being stretched | | | After being stretched by 30% | | | After being stretched by 100% | | |
|---|---|---|---|---|---|---|---|---|
| Pitch | Width (H) | Space (S) | Pitch | Width (H) | Space (S′) | Pitch | Width (H) | Space (S′) |
| [μm] | [μm] | [μm] | [μm] | [μm] | [μm] | [μm] | [μm] | [μm] |
| 350 | 175 | 175 | 455 | 175 | 280 | 700 | 175 | 525 |
| 300 | 150 | 150 | 390 | 150 | 240 | 600 | 150 | 450 |
| 250 | 125 | 125 | 325 | 125 | 200 | 500 | 125 | 375 |
| 200 | 100 | 100 | 260 | 100 | 160 | 400 | 100 | 300 |
| 150 | 75 | 75 | 195 | 75 | 120 | 300 | 75 | 225 |
| 100 | 50 | 50 | 130 | 50 | 80 | 200 | 50 | 150 |
| 50 | 25 | 25 | 65 | 25 | 40 | 100 | 25 | 75 |
| 10 | 5 | 5 | 13 | 5 | 8 | 20 | 5 | 15 |
| 5 | 2.5 | 2.5 | 6.5 | 2.5 | 4 | 10 | 2.5 | 7.5 |
| 1 | 0.5 | 0.5 | 1.3 | 0.5 | 0.8 | 2 | 0.5 | 1.5 |
| 0.5 | 0.25 | 0.25 | 0.65 | 0.25 | 0.4 | 1 | 0.25 | 0.75 |
| 0.1 | 0.05 | 0.05 | 0.13 | 0.05 | 0.08 | 0.2 | 0.05 | 0.15 |

For example, when the curvature radius r of the tip of the touch pen TP is set to be 0.5 mm and the thickness d of the coating tile 231 is 10 μm, referring to Table 1, the allowed maximum gap S may be appreciated to be about 199 μm. Referring to Table 2, the case in which the maximum gap S′ is set to be 200 μm when the window substrate 200 is stretched by 30% is the maximum allowable value and the case in which the gap S′ is 150 μm when the window substrate 200 is stretched by 100% is the maximum allowable value.

Therefore, when the elongation of the window substrate 200 is 30%, the width H and the maximum gap S of the coating tile 231 may each be set to be up to 125 μm and when the elongation of the window substrate 200 is 100%, the width H and the maximum gap S of the coating tile 231 may each be set to be up to 50 μm.

However, the above-mentioned design value is suggested for an exemplary description and therefore the range of the present invention is not limited thereto.

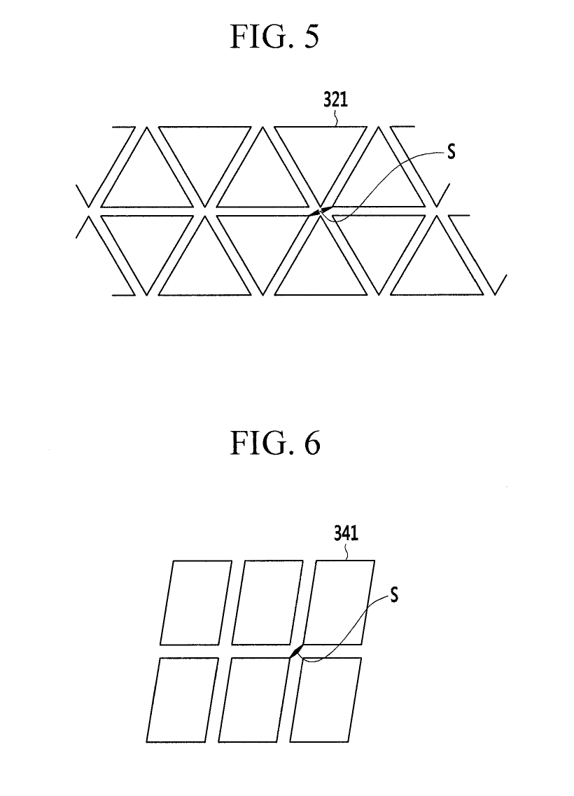

FIG. 5 is a plan view illustrating a coating layer pattern formed on a window substrate of a flexible display device according to another exemplary embodiment.

Referring to FIG. 5, the coating layer of the window substrate according to yet another exemplary embodiment includes a coating tile 321 having a triangular plane shape. The coating layer may be disposed so that respective corners of six of the triangular coating tiles 321 are adjacent to a point.

A space between adjacent sides of each coating tile 321 may be uniformly formed over the whole of the coating layer. Further, the allowable maximum gap S between the coating tiles 321 may be a space formed between the corners of the coating tile 321 facing each other to be symmetrical to each other.

FIG. 6 is a plan view illustrating a coating layer pattern formed on a window substrate of a flexible display device according to still another exemplary embodiment.

Referring to FIG. 6, the coating layer of the window substrate according to an exemplary embodiment includes a coating tile 341 having a parallelogrammic plane shape. The coating layer is disposed so that respective corners of four of the parallelogrammic coating tiles are adjacent to one point and is arranged in the same or substantially the same inclination direction.

A gap between adjacent sides of each coating tile 341 may be uniformly formed over the whole of the coating layer. Further, the allowable maximum gap S between the coating tiles 341 may be a space formed between the corners of the coating tile 341 facing each other to be symmetrical to each other.

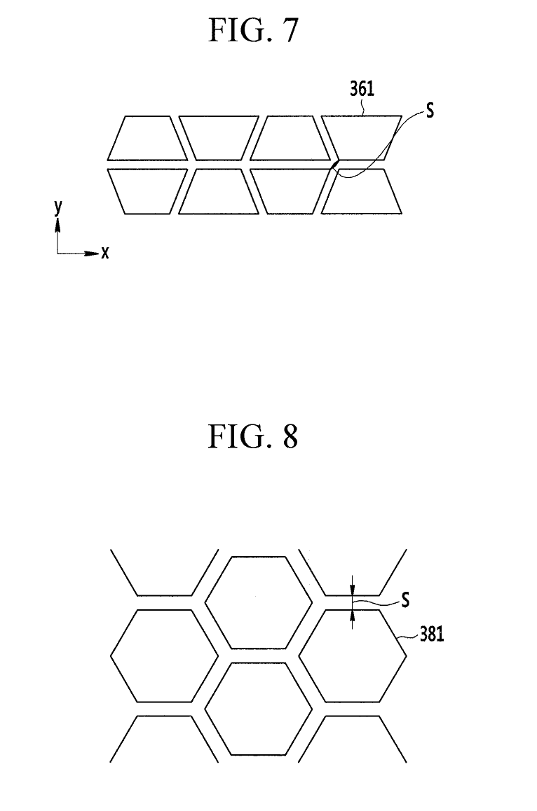

FIG. 7 is a plan view illustrating a coating layer pattern formed on a window substrate of a flexible display device according to still another exemplary embodiment.

Referring to FIG. 7, the coating layer of the window substrate according to tan exemplary embodiment includes a coating tile 361 having a trapezoidal plane shape. The coating layer is disposed so that respective corners of four of the trapezoidal coating tiles 361 are adjacent to one point and the trapezoids adjacent to each other in a first direction (x-axis direction in the drawings) may be arranged to be alternately reversed so that the inclined sides are parallel with each other. That is, the coating layer may be arranged so that sections of the trapezoids adjacent to each other in a second direction (y-axis direction in the drawings) intersecting (e.g., crossing) the first direction face each other and long sides face each other.

A gap between adjacent sides of adjacent ones of the coating tile 361 may be uniformly formed over the whole of the coating layer. Further, the allowable maximum gap S between the coating tiles 361 may be a gap formed between the corners of the coating tile 361 facing each other to be symmetrical to each other.

FIG. 8 is a plan view illustrating a coating layer pattern formed on a window substrate of a flexible display device according to still another exemplary embodiment.

Referring to FIG. 8, the coating layer of the window substrate according to an exemplary embodiment includes a coating tile 381 having a hexagonal plane shape. The coating layer may be disposed so that respective corners of three of the hexagonal coating tiles 381 are adjacent to a point.

A gap between adjacent sides of each coating tile 381 may be uniformly formed over the entire coating layer. Further, the allowable maximum gap S between the coating tiles 381 may be a gap which is formed between the adjacent sides of the coating tiles 381.

While this disclosure has been described in connection with what is presently considered to be practical exemplary embodiments, it is to be understood that the invention is not limited to the disclosed embodiments, but, on the contrary, is intended to cover various suitable modifications and equivalent arrangements included within the spirit and scope of the appended claims, and their equivalents.

Description of some of the symbols

| | |
|---|---|
| 10: Flexible display device | 100: Display panel |
| 115: Display panel adhesive layer | 120: Lower protective film |
| 125: TSP adhesive layer | 150: Touch screen panel |

| | |
|---|---|
| 175: Window adhesive layer | 200: Window substrate |

| | |
|---|---|
| 210: Base layer | 230: Coating layer |

231, 321, 341, 361, 381: Coating tile

What is claimed is:

1. A flexible display device, comprising:
a display panel for displaying an image;
a touch screen panel on the display panel; and
a window substrate covering the touch screen panel,
wherein the window substrate comprises:
a flexible base layer comprising a first surface facing an outside and a second surface facing the display panel in an opposite direction to the first surface; and
a coating layer having hardness higher than that of the base layer and comprising a plurality of coating tiles arranged on the first surface of the base layer thereof, each coating tile being spaced from adjacent ones of the coating tiles.

2. The flexible display device of claim 1,
wherein the plurality of coating tiles are each isolated from each other.

3. The flexible display device of claim 1,
wherein the plurality of coating tiles are arranged in a matrix form.

4. The flexible display device of claim 1,
wherein the window substrate is divided into a display area configured to display an image and a non-display area which encloses the display area, and
wherein the coating layer is at an area which corresponds to the display area.

5. The flexible display device of claim 1,
wherein a thickness of the coating tiles is between 10 μm and 100 μm.

6. The flexible display device of claim 1,
wherein when:
a curvature radius of a tip of a touch pen which is used by contacting a surface of the window substrate is set to be r, and
a thickness of the coating tiles is set to be d, and a maximum gap between the coating tiles adjacent to each other is set to be S,
the maximum gap to satisfies
S≦2\sqrt{d(2r−d)}.

7. The flexible display device of claim 1,
wherein a gap between the coating tiles adjacent to each other is between 20 μm and 200 μm.

8. The flexible display device of claim 1,
wherein the coating tiles have a quadrangular plane shape.

9. The flexible display device of claim 8,
wherein the coating tiles have a parallelogrammic plane shape, and
wherein the coating tiles are arranged so that respective corners of four of the parallelogrammic coating tiles are adjacent to one point and the coating tiles are arranged with the same inclination direction.

10. The flexible display device of claim 8,
wherein the coating tiles have a trapezoidal plane shape,
wherein the coating tiles are arranged so that respective corners of four of the trapezoid coating tiles are adjacent to one point, and
wherein inclined sides of the trapezoids adjacent to each other in a first direction are alternately reversed and arranged to be parallel with each other.

11. The flexible display device of claim 1,
wherein the coating tiles have a triangular plane shape.

12. The flexible display device of claim 11,
wherein the coating tiles are arranged so that respective corners of six of the triangular coating tiles are adjacent to a point.

13. The flexible display device of claim 12,
wherein an allowable maximum gap between the coating tiles is between the corners of the coating tiles facing each other to be symmetrical to each other.

14. The flexible display device of claim 1,
wherein the coating tiles have a hexagonal plane shape.

15. The flexible display device of claim 14,
wherein the coating tiles are arranged so that respective corners of three of the hexagonal coating tiles are adjacent to a point.

16. The flexible display device of claim 15,
wherein an allowable maximum gap between the coating tiles is a gap which is between adjacent sides of the coating tiles.

17. The flexible display device of claim 1,
wherein the base layer comprises a material selected from the group consisting of elastomer, polyethylene terephthalate (PET), polyethylene naphthalate (PEN), polyimide (PI), polymethyl methacrylate (PMMA), silicone, polyurethane (PU), and combinations thereof.

18. The flexible display device of claim 1,
wherein the coating tiles are made of a material selected from the group consisting of epoxy, acryl, silicone, polyurethane (PU), graphene, carbon nanotube (CNT), indium tin oxide (ITO), indium zinc oxide (IZO), Si, SiOx, SiNx, and combinations thereof.
